(19) United States
(12) Patent Application Publication
(10) Pub. No.: US 2026/0138251 A1
(43) Pub. Date: May 21, 2026

(54) GEARBOX FOR AUTOMOTIVE SERVICE WITH PLANETARY GEAR

(71) Applicant: Robert Bosch GmbH, Stuttgart (DE)

(72) Inventors: Daniel Newkirk, Owatonna, MN (US); Robert Kochie, Dodge Center, MN (US); Dennis Hanson, Medford, MN (US)

(21) Appl. No.: 18/953,363

(22) Filed: Nov. 20, 2024

(51) Int. Cl. B25B 29/00; B25B 27/30; B25H 1/00; F16H 1/28

(52) U.S. Cl. CPC B25B 29/00; F16H 1/28; B25B 27/304; B25H 1/0007; F16H 2001/2881

(57) ABSTRACT

A gearbox and gearbox apparatus for use in automotive service. The gearbox comprises a planetary gear and a transfer gear. The gearbox is suitable to be driven by torque from an input driver, and to transfer torque to a target device.

### TECHNICAL FIELD

This disclosure relates to automotive service, and more specifically tools used during automotive service.

### BACKGROUND

Automotive service tools include a variety of stands and supports that utilize rotational forces to position or brace components during service. Conventional stands and supports utilize manual operation of the rotational controls, which can be fatiguing and require extensive manual rotations of the controls.

What is desired is a way of minimizing the manual effort needed to make rotational adjustments during service, both to advantageously increase the speed of the adjustment time and to decrease the manual force necessary to make the adjustments.

### SUMMARY

One aspect of this disclosure is directed to a gearbox comprising a housing, a rotational input, a planetary gear, a transfer gear, and a rotational output. The rotational input has a first geometry and is engaged with the planetary gear. The planetary gear is further engaged with the transfer gear. The transfer gear has a larger diameter than the planetary gear. The rotational output has a second geometry and is engaged with the transfer gear. The housing at least partially covers the planetary gear and the transfer gear, and at least partially defines a recess supporting the rotational input. Torque is transferred from the rotational input to the planetary gear, from the planetary gear to the transfer gear, and from the transfer gear to the rotational output. The rotational output may engage a target device to deliver the torque. The second geometry of the rotational output comprises a stabilizer to engage with a mount of a target device receiving torque from the rotational output.

Another aspect of this disclosure is directed to a gearbox apparatus comprised of an input driver and a gearbox. The gearbox comprises a housing, a rotational input, a planetary gear, a transfer gear, and a rotational output. The rotational input has a first geometry and is engaged with the planetary gear. The planetary gear is further engaged with the transfer gear. The transfer gear has a larger diameter than the planetary gear. The rotational output has a second geometry and is engaged with the transfer gear. The housing at least partially covers the planetary gear and the transfer gear, and at least partially defines a recess supporting the rotational input. Torque is transferred from the rotational input to the planetary gear, from the planetary gear to the transfer gear, and from the transfer gear to the rotational output. The rotational output may engage a target device to deliver the torque. The second geometry of the rotational output comprises a stabilizer to engage with a mount of a target device receiving torque from the rotational output. The input driver comprises a powered input driver to deliver torque to the rotational input, such as an electric screw driver or an air-compressor gun.

The above aspects of this disclosure and other aspects will be explained in greater detail below with reference to the attached drawings.

### BRIEF DESCRIPTION OF THE DRAWINGS

FIG. 1 is an illustration of a gearbox apparatus used in conjunction with a strut compressor.

FIG. 2 is an exterior illustration of a gearbox.

FIG. 3 is an interior view of the gearbox of FIG. 2.

FIG. 4 is an exploded view of the gearbox of FIG. 2.

FIG. 5 is an illustration of a gearbox apparatus used in conjunction with a rotating engine stand.

### DETAILED DESCRIPTION

The illustrated embodiments are disclosed with reference to the drawings. However, it is to be understood that the disclosed embodiments are intended to be merely examples that may be embodied in various and alternative forms. The figures are not necessarily to scale and some features may be exaggerated or minimized to show details of particular components. The specific structural and functional details disclosed are not to be interpreted as limiting, but as a representative basis for teaching one skilled in the art how to practice the disclosed concepts.

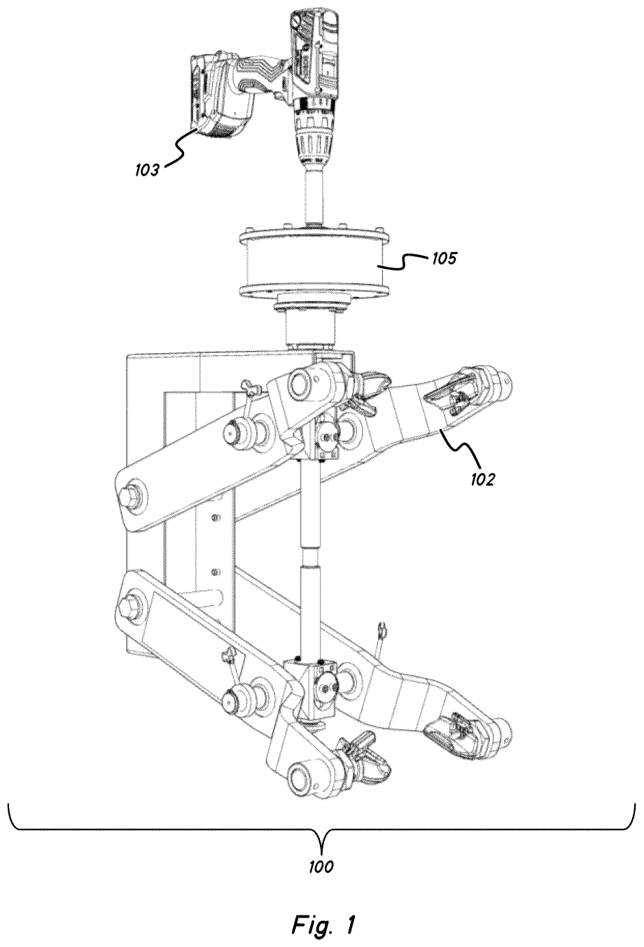

FIG. 1 is an illustration of a gearbox apparatus 100 comprising a target device 102, an input driver 103, and a gearbox 105. In the depicted embodiment, target device 102 comprises a strut compressor (sometimes also called a “strut tamer”) 102, but other embodiments may comprise other configurations without deviating from the teachings disclosed herein. Strut compressor 102 conventionally applies force to an automotive strut suitable for use with a car, truck, or other automobile. Because the tension of a strut may be quite large, strut compressor 102 must be capable of applying a large deal of force to the strut to safely maintain the form of the strut spring during service of the strut, or during service of an associated vehicle that requires a strut to be removed. Application of this force is typically manually applied using a rotational input, which can be cumbersome and tiring for a user to apply (and remove at the completion of service). Gearbox 105 advantageously permits a user to utilize input driver 103 to quickly and safely apply torque to the input of strut compressor 102 by utilizing mechanical advantage between gears of the gearbox (described later).

The input driver 103 in the depicted embodiment comprises an electric screwdriver 103 powered by a battery, but other embodiments may comprise other configurations without deviating from the teachings disclosed herein. In some such embodiments, input driver 103 may comprise an air-compression gun without deviating from the teachings disclosed herein. In such embodiments, input driver 103 comprises a powered input driver: an electric screw driver is powered by an electric battery and an air-compression gun is powered by pneumatic differentials. Non-powered input drivers may also be utilized without deviating from the teachings disclosed herein. In such embodiments, a non-powered input driver may still provide a user with a mechanical advantage suitable to drive the target device 102. Other such embodiments may comprise alternative configurations for a powered input driver 103 such as an electric drill, electric rotary tool, or other powered tool to apply torque recognized by one of ordinary skill in the art without deviating from the teachings disclosed herein.

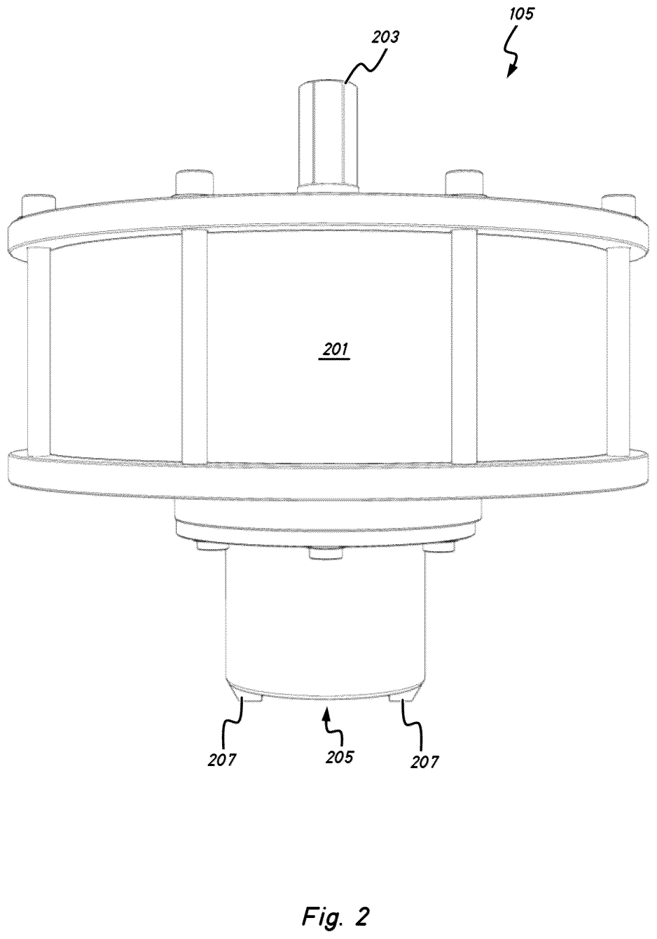

FIG. 2 is an exterior illustration of gearbox 105, showing some features thereof. Gearbox 105 comprises a housing 201 that protects other components of gearbox 105. Gearbox 105 additionally comprises a rotational input 203 which is configured to accept rotation and torque from an external driver (such as input driver 103; see FIG. 1). In the depicted embodiment, gearbox 105 comprises a single rotational input 203, but other embodiments may comprise a different number without deviating from the teachings disclosed herein. In the depicted embodiment, the rotational input 103 comprises a first geometry suitable to receive a driver, but other embodiments may comprise a different configuration having different geometries suitable to engage with different bit designs. In the depicted embodiment, the first geometry of rotational input 203 is suitable to receive a half-inch square bit, making the rotational inputs 203 suitable to engage with a bit from an input driver 103 in the form of an electric screwdriver. Other embodiments may comprise a different configuration without deviating from the teachings disclosed herein.

Gearbox 105 additionally comprises a rotational output 205 having a second geometry suitable to engage with a target device (such as target device 102; see FIG. 1). The second geometry of rotational output 105 advantageously engages with a matching receptacle of the specified target device in shape. In the depicted embodiment, rotational output 205 additionally comprises a set of stabilizers 207 within the second geometry, which advantageously stabilize the engagement of gearbox 105 with the associated target device and additionally optimize transfer of torque from gearbox 105 to the torque input of the target device. In the depicted embodiment, stabilizers 207 are rectangular projections, but other embodiments may comprise a different configuration, number, or arrangement of stabilizers 207 without deviating from the teachings disclosed herein. Some embodiments may not comprise stabilizers 207 without deviating from the teachings disclosed herein.

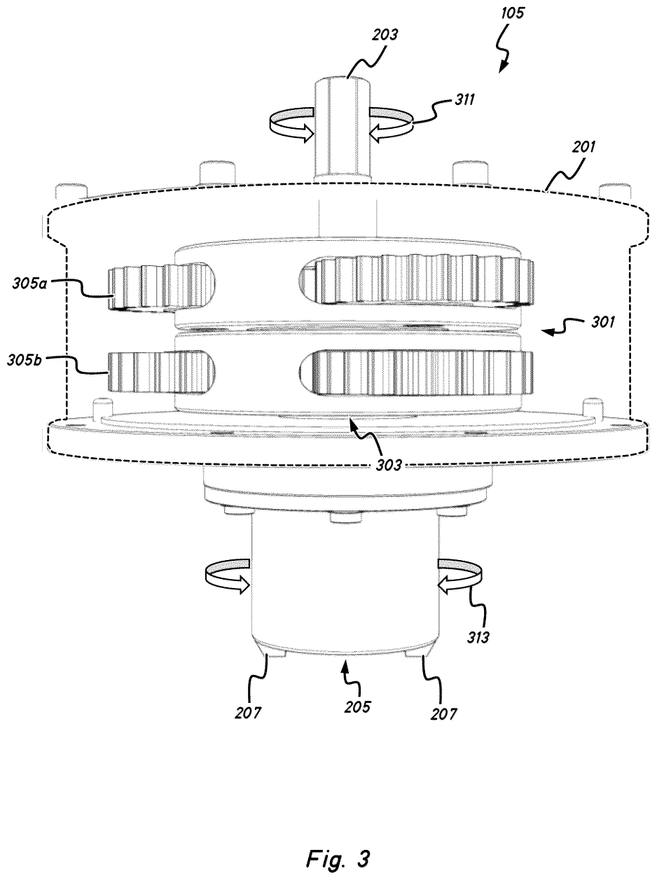

FIG. 3 is a view of gearbox 105 showing internal components disposed within housing 201. Engaged with each of rotational inputs 203 is a planetary gear 301 which receives torque from one or more of the rotational inputs 103 and transfers the torque to a transfer gear 303. Transfer gear 303 is engaged with rotational output 205 and transfers the received to torque to the rotational output 205 to engage with the target device (such as target device 102; see FIG. 1).

Planetary gear 301 magnifies the torque applied at the rotational input 203. In the depicted embodiment, rotational torque 311 applied along the rotational axis of planetary gear 301 at a rotational input 203 is converted by the planetary gear 301 into rotational torque 313 that is applied along the rotational axis of transfer gear 303. Transfer gear 303 and rotational output 205 have the same rotational axis, optimizing transfer of the torque to the rotational output 205 (and subsequently, to the target device).

The gear ratios of planetary gear 301 and transfer gear 303 are significant, as an appropriate gear ratio advantageously optimizes operation of gearbox 105 with an appropriate target device. In the depicted embodiment, the gear ratio of the transfer gear and the planetary gear may be between 20:1 and 60:1 for use with a high-torque target device, such as a strut compressor 102 (see FIG. 1). In this depiction, the ratio is 50:1, but the ratio may be selectively adjusted to accommodate a different target device, or a target device having a different specification. In some such embodiments configured for use with a different target device (such as an engine stand), the gear ratio may be different to provide for different functional behaviors. In some such embodiments, the gear ratio may be between 10:1 and 30:1, which advantageously permits faster rotations at the target device without requiring as much energy from the input driver (such as input driver 103; see FIG. 1).

In the depicted embodiment, planetary gear 301 is a multi-stage planetary gear comprised of a pair of planetary gear assemblies 305a and 305b. Planetary gear assemblies 305 provide the mechanical advantage to rotational torque 313. In the depicted embodiment, there are two planetary gear assemblies 305, but other embodiments may comprise a single stage planetary gear or a different number of planetary gear stages without deviating from the teachings disclosed herein.

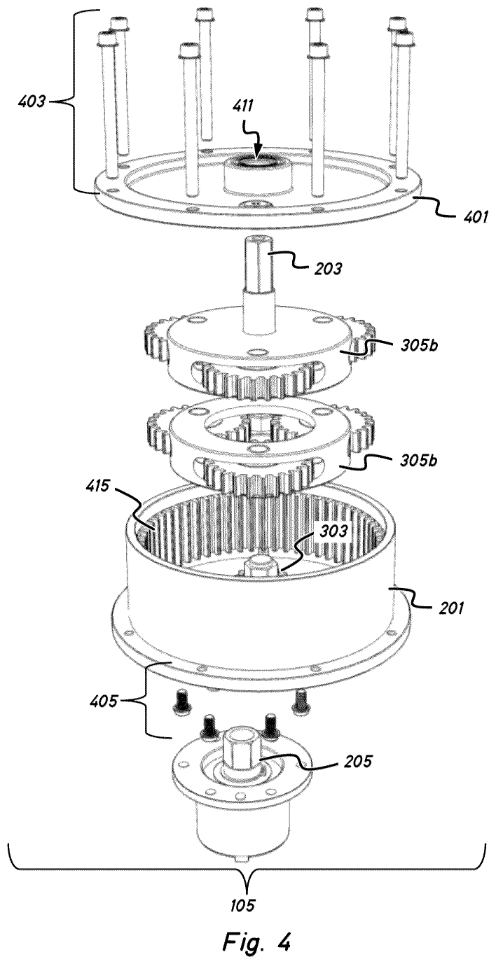

FIG. 4 is an exploded view of gearbox 105, showing additional features. Housing 201 further comprising a housing cover 401 that is utilized to access and arrange components disposed within the housing 201 during assembly of gearbox 105. Fasteners 403 and 405 are utilized to couple the components together in operational arrangement. Additionally, housing 201 additionally comprises recess 411 suitable to support the rotational input 203. The recess 411 permits engagement of planetary gear 301 via one of the rotational inputs 203.

Additionally visible in this view is a housing gear 415. Housing gear 415 provides a matching gearing that engages the teeth of planetary gear assemblies 305, which advantageously allows them to properly engage transfer gear 303 to transfer torque to rotational output 205. In the depicted embodiment, housing gear 415 is disposed within an inner surface of housing 201, but other embodiments may comprise a different arrangement without deviating from the teachings disclosed erein.

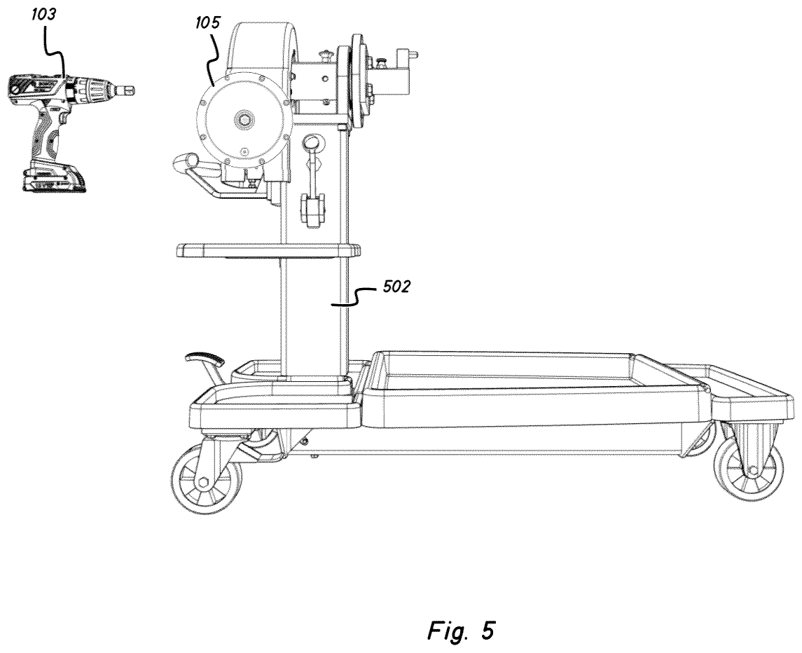

FIG. 5 is an alternative embodiment of a gearbox apparatus 500 to the gearbox apparatus 100 depicted in FIG. 1. In the depicted embodiment, target device 502 comprises a rotating engine stand, suitable for supporting and positioning an engine or other vehicular prime mover during service. In this embodiment, gearbox 105 is utilized to assist a user in finding the desired rotational position of an engine during service by providing a more rapid rotation with suitable fine control. In this embodiment, gearbox 105 may comprise a gear ratio of 20:1, to provide optimized behavior when in use with engine stand 502. In some embodiments of gearbox 105, the planetary gear 301 and/or transfer gear 303 (not shown; see FIG. 3, FIG. 4) may be field-interchangeable components, permitting a user to adjust the gearbox 105 for optimal use cases. Other embodiments may comprise other configurations without deviating from the teachings disclosed herein.

While exemplary embodiments are described above, it is not intended that these embodiments describe all possible forms of the disclosed apparatus and method. Rather, the words used in the specification are words of description rather than limitation, and it is understood that various changes may be made without departing from the spirit and scope of the disclosure as claimed. The features of various implementing embodiments may be combined to form further embodiments of the disclosed concepts.

What is claimed is:

1. A gearbox comprising:
a housing;
a rotational input having a first geometry;
a planetary gear engaged with the rotational input;
a transfer gear engaged with the planetary gear, the transfer gear having a larger diameter than the planetary gear; and
a rotational output having a second geometry and engaging the transfer gear,
wherein
the housing at least partially covers the planetary gear and the transfer gear and at least partially defines a recess supporting the rotational input, and
the second geometry comprises a stabilizer to engage with a target device receiving torque from the rotational output.

2. The gearbox of claim 1, wherein the planetary gear comprises a two-level planetary gear.

3. The gearbox of claim 1, wherein the gear ratio between the transfer gear and the planetary gear is at least 50:1.

4. The gearbox of claim 1, wherein the first geometry is compatible to receive a half-inch square drive bit.

5. The gearbox of claim 1, wherein the rotational output is compatible to engage a strut compressor.

6. The gearbox of claim 1, wherein the rotational output is compatible to engage an engine stand.

7. The gearbox of claim 1, wherein the second geometry comprises a stabilizer to engage a target device of the gearbox.

8. The gearbox of claim 1, wherein the rotational input is compatible to be driven by an electric screwdriver.

9. The gearbox of claim 1, wherein the rotational input is compatible to be driven by an air-compression gun.

10. A gearbox apparatus comprising:
a gearbox having
a housing,
a rotational input having a first geometry,
a planetary gear engaged with the rotational input,
a transfer gear engaged with the planetary gear, the transfer gear having a larger diameter than the work gear, and
a rotational output having a second geometry and engaging the transfer gear; and
a powered input driver,
wherein
the housing at least partially covers the planetary gear and the transfer gear and at least partially defines a recess supporting the rotational input,
the powered input driver is compatible with the first geometry, and
wherein the second geometry comprises a stabilizer to engage with a target device receiving torque from the rotational output.

11. The gearbox apparatus of claim 10, wherein the gear ratio between the transfer gear and the planetary gear is at least 50:1.

12. The gearbox apparatus of claim 10, wherein the powered input driver comprises an electric screwdriver.

13. The gearbox apparatus of claim 12, the electric screw gun comprising a half-inch square drive bit, and the first geometry being compatible to receive a half-inch square drive bit.

14. The gearbox apparatus of claim 10, wherein the powered input driver comprises an air-compression gun.

15. The gearbox apparatus of claim 10, wherein the rotational output is compatible to engage a strut compressor.

16. The gearbox apparatus of claim 10, wherein the rotational output is compatible to engage an engine stand.

17. The gearbox of claim 10, wherein the second geometry comprises a stabilizer to engage a target device of the gearbox.
